(19) United States
(12) Patent Application Publication
(10) Pub. No.: US 2002/0069738 A1
(43) Pub. Date: Jun. 13, 2002

(54) Portable bandsaw mill

(76) Inventor: Martin Gagne, St-Gedeon (CA)

Correspondence Address: Eric Fincham, 316 Knowlton Road, Lac Brome, QC, JOE 1VO, CA

(21) Appl. No.: 09/933,529

(22) Filed: Aug. 20, 2001

Related U.S. Application Data
(63) Continuation-in-part of application No. 09/117,255, filed on Nov. 12, 1998, now abandoned.
Application No. 09/117,255 is a continuation-in-part of application No. PCT/CA97/00959, filed on Nov. 19, 1997.

(30) Foreign Application Priority Data
Nov. 28, 1996 (CA) 2,191,492

(51) Int. Cl. B26D 7/08

(52) U.S. Cl. 83/171; 83/170; 83/788

(57) ABSTRACT

A portable bandsaw mill for sawing logs which has an elevated horizontal rail extending between first and second end frames, a carriage component mounted on the rail and means slidably movable therealong, a drive motor and a saw blade assembly mounted on opposite sides of the horizontally extending rail to substantially counterbalance each other, and a log support extending between the first and second end frames, the log support being inclined. The above arrangement permits a very light compact sawmill which may be easily transported and set up at different sites.

This is a Continuation in Part of application Ser. No. 09/117,255, filed Nov. 8, 2000, which is a Continuation in Part of application Ser. No. 09/117,255, filed May 22, 2000 which is a Continuation in Part of application Ser. No. 09/117,255, filed Jul. 12, 1999, which is a Continuation in Part of application PCT/CA97/00959, filed Nov. 19, 1997.

### FIELD OF THE INVENTION

The present invention relates to the field of saws and is particularly concerned with a portable bandsaw mill for sawing logs.

### BACKGROUND OF THE INVENTION

It is highly desirable to obtain, when sawing logs, an excellent quality of construction wood. The portable mill structure has to be very solid to counter the forces of bending and turning created by the weight of the wood and the mechanical components of the bandsaw.

Portable bandsaw mills are intended to be easily transportable to a site hence the importance of the mill's weight.

It has been shown that portable bandsaw mills that have only one beam to support the mechanical bandsaw unit subject the rail that carries the ;mobile saw carriage to a lot of twisting due to the weight of the bandsaw and the motor. This is why this type of mill needs to have a large structure, which results in a greater weight. An example of this type of mill is described in U.S. Pat. No. 4,559,858.

### SUMMARY OF THE INVENTION

It is an object of the present invention to provide a portable bandsaw mill which is lightweight and easily transportable from one load site to another and is easily set up.

It is a further object of the present invention to provide a portable bandsaw mill which has a longitudinal rail which may be made lightweight as it is not required to be resistant to a twisting or torque.

According to one aspect of the present invention, there is provided a portable sawmill for sawing a log, this sawmill comprising first and second end frames, an elevated horizontally extending rail extending between and supported by the first and second end frames, a carriage component mounted on the horizontally extending rail and being slidably moveable therealong, a cutting means carried by the carriage, the cutting means including a drive motor and a saw blade assembly, the drive motor and the saw blade assembly being mounted on the carriage component such that each of the drive motor and the saw blade assembly are on opposite sides of the horizontally extending rail to thereby substantially counterbalance each other, log support means extending between the first and second end frames, the log support means being located below the elevated horizontally extending rail, the log support means including a log support surface inclined with respect to a horizontal plane.

The bandsaw mill of the present invention distributes the weight of the motor of the bandsaw in order to prevent as much as possible the moment of turning on the mobile saw carriage. There is thus provided a bandsaw structure whose components are distributed in such a way that the weight does not create any moment of turning on the mobile carriage. The motor is set up at one end of a horizontal beam and on the other side of the beam, there is another beam welded and which is slightly tilted off the vertical on which the mechanical components of the bandsaw are placed. The wheels of the mobile carriage are placed under the horizontal beam, between the motor and the mechanical components of the bandsaw. Thus the head of the bandsaw can move evenly in a longitudinal direction on the rail. Since the rail is not subjected to any twisting force, a smaller, lighter rail can be used.

Furthermore, while mills saw logs either transversely or longitudinally in both cases the logs must be laid horizontally. The bottom surface of a round log has only a very small are which contacts a supporting surface. Mills are thus required to use complex bolting equipment to prevent the log from turning to one side or the other during sawing. Another feature of the bandsaw mill of the present invention is that it saws this type of log on an off-vertical angle, and the log is laid on a surface perpendicular to this angle. With this method, forces are broken down into x and y by gravity, creating two support surfaces during sawing and a great stability, with no need to use complex bolting equipment.

It is known that the cutting line of bandsaws can be affected when the rail is directly connected to the log support, and is therefore constantly subject to bending due to the weight of the log. These mills therefore have to use large structures which increase the weight of the machine. The bandsaw mill of the present invention has a supporting end frame at each end of the log which supports both the log and the ends of the rail. The fact that the weight is solely concentrated on these two support points and not along the length of the rail means that the rail is not subject at any time to bending, and a lighter structure can therefore be used.

Another problem with bandsaw mills is that when the machine is in operation, sawdust tends to accumulate in the wheels, affecting the tension of the blade. To counter this effect, sawmills use costly equipment to automatically adjust the tension. Another feature of the bandsaw mill of the present invention is that at one end it simply uses an exhaust pipe directly connected to the motor's exhaust system, and at the other end, the air pressure is regulated so that the sawdust is blown off the path of the wheel. This eliminates the need for a machine that automatically adjusts the tension.

There is also provided a pick in the shape of a rake which prevents any rotation at the end of the log. This pick has a metal handle with a welded ring at one end that can slide along a shaft that runs parallel to the log. At the other end of the pick is a welded serrated shaft that is perpendicular to the handle and is inserted into the end of the log to lock it.

### BRIEF DESCRIPTION OF THE DRAWINGS

Having thus generally described the invention, reference will be made to the accompanying drawings illustrating an embodiment thereof, in which:

FIG. 1 has a side and end elevational view of an embodiment of a portable bandsaw mill according to the present invention;

FIG. 2A is a top plan view of the head of the bandsaw;

FIG. 2B is a side view of the head of the bandsaw;

FIG. 3 is a side view of the supporting beams;

FIG. 4 is a top plan view of the supporting beams;

FIG. 5 is a side view of the blade tension regulation system;

FIG. 6 is the blade guiding system; and

FIG. 7 is a side view of the bandsaw base guiding system.

### DESCRIPTION OF THE PREFERRED EMBODIMENTS

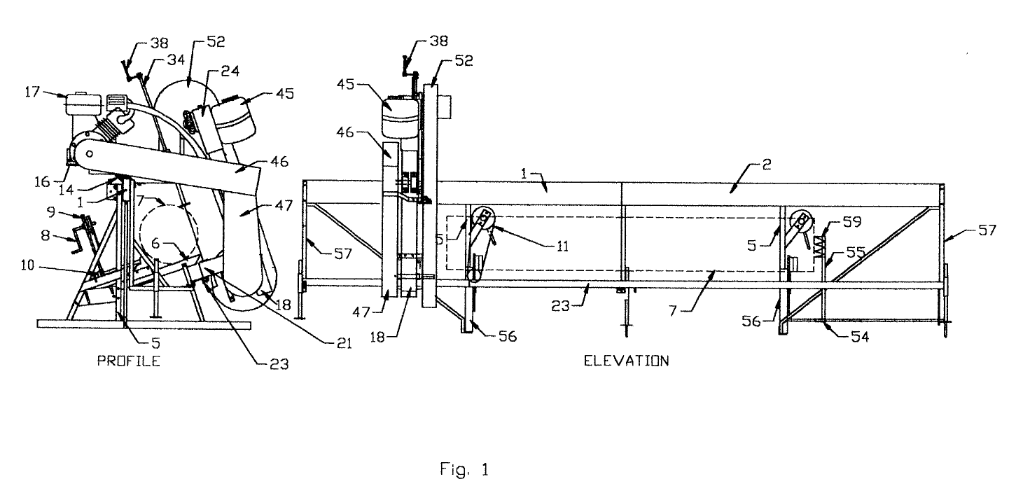

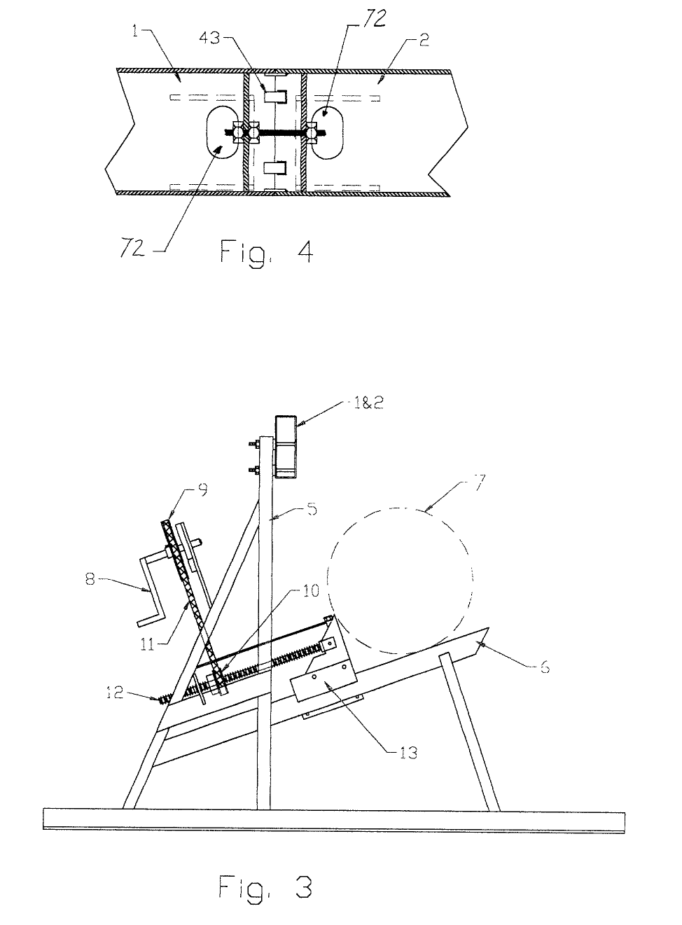

The invention shown in FIG. 1 includes a rail made up of two sections of metal tubular beams 1 and 2. At one end of beam 2, there are small plates 43 welded onto its interior surface (see FIG. 4). The beams are connected by inserting the small plates into the other end of beam 1 (see FIG. 4). The rail can be lengthened to the desired length using several beam sections.

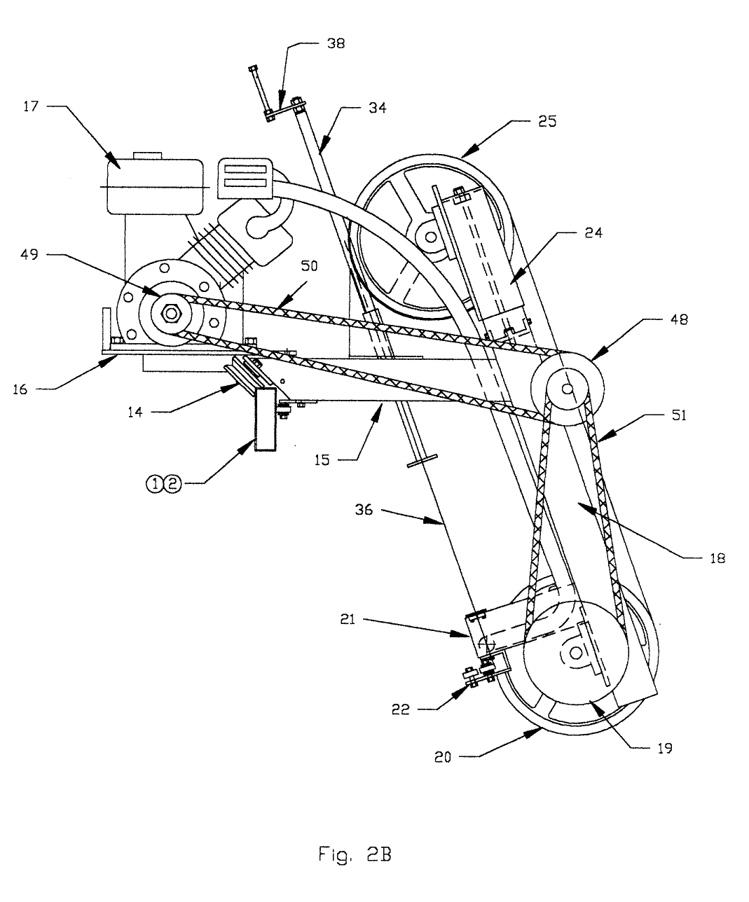

The rail is bolted down onto two end frames (FIG. 3). These end frames are made up of: a vertical tubular bar 5 that supports the rail, a flat bar 6 that supports the log 7, and advancing device that allows the log to slide along the flat bar 6 in order to adjust the thickness of the saw cut. The advancing device for the log has a handle 8 connected to the pulley 9 which in turn is connected to the pulley 10 by a driving belt 11. By rotating the pulley 10, the transmission bolt 12, which is parallel to the flat bar 6, is either tightened or loosened, and the flat bar in turn pushes or pulls the shoulder plate of the log 13.

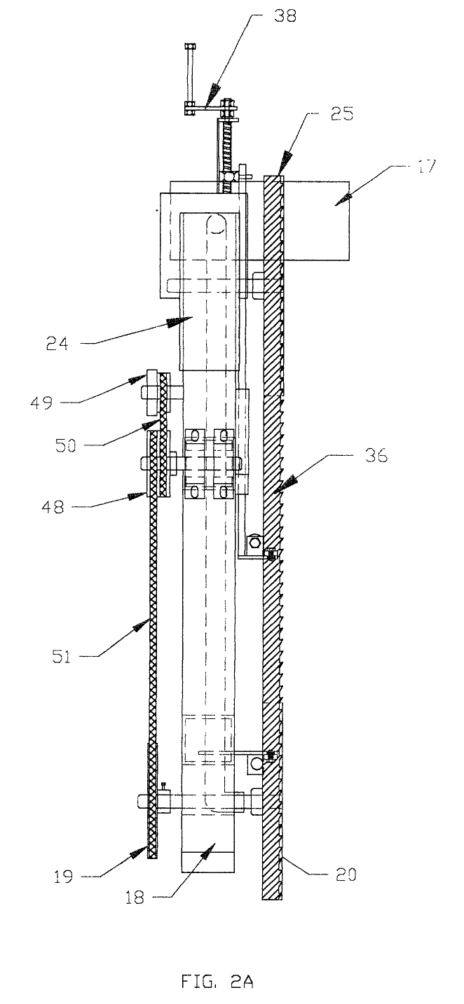

The head of the bandsaw (FIGS. 2B and 2A) rests on the rail with a roller 14 that acts as a mobile saw carriage. The head of the bandsaw comprises a horizontal beam 15 that carries the support plate 16 of the motor 17 at one end. Welded onto the other end of this horizontal beam, is another beam 18 that is tilted off the vertical and is perpendicular to flat metal bars 6 set up on the supporting end frames (FIG. 3). The bottom end of this beam 18 supports the driving pulley 19 and the driving wheel 20 of the bandsaw blade 36. Likewise, welded onto this beam 18 is another tubular beam 21, so that both are perpendicular to each other.

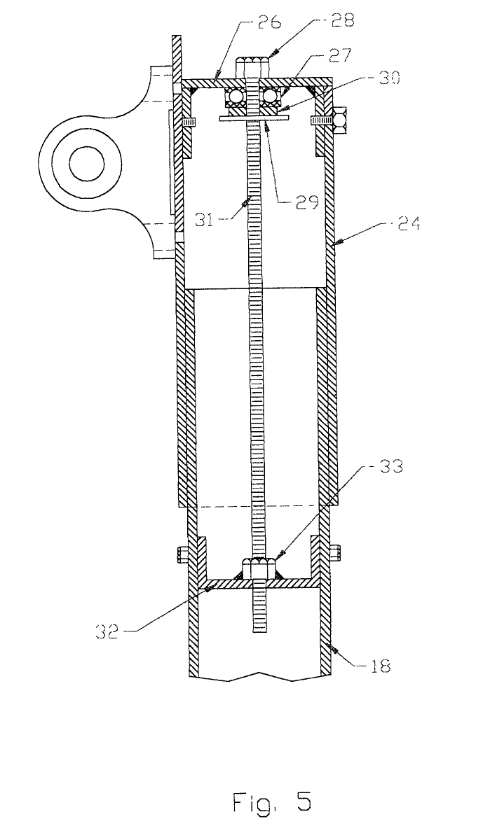

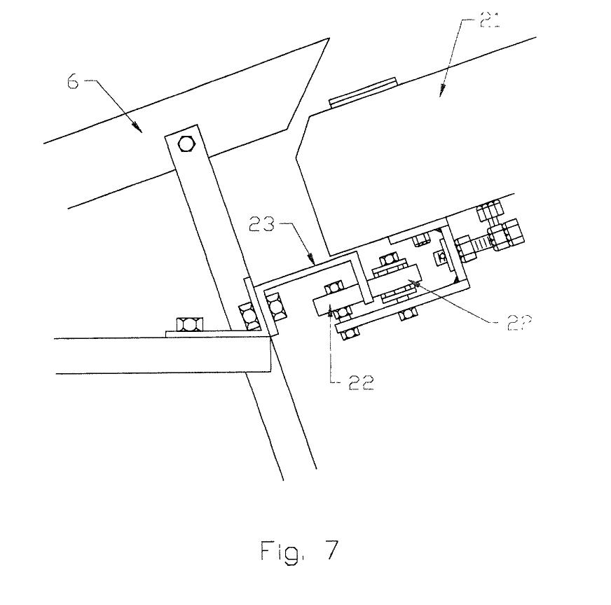

Onto this beam 21, we have installed a rolling bolting device 22 (see FIG. 7) which rolls and secures the bottom of the bandsaw along the guide track 23 parallel to the rail. Four metal plates are welded in order to obtain a tubular block 24 that surrounds, extends along, and is firmly attached to the upper edge of the beam 18. This tubular block 24 secures the driving wheel 25 of the blade 36. FIG. 5 shows the tension regulation system used to adjust the blade. As illustrated in FIG. 5, the plate 26 was designed to be bolted onto the tubular block 24 and to support the ball bearing 27, and a transmission bolt 31 at the top end of which a bolt 28 is attached by welding. A stop bolt 29 allows the washer 30 which pushes on the ball bearing to be stopped. At the other end of the transmission bolt, a plate 32 has been bolted to the beam 18 and a bolt 33 has been welded, allowing the transmission bolt to be easily tightened.

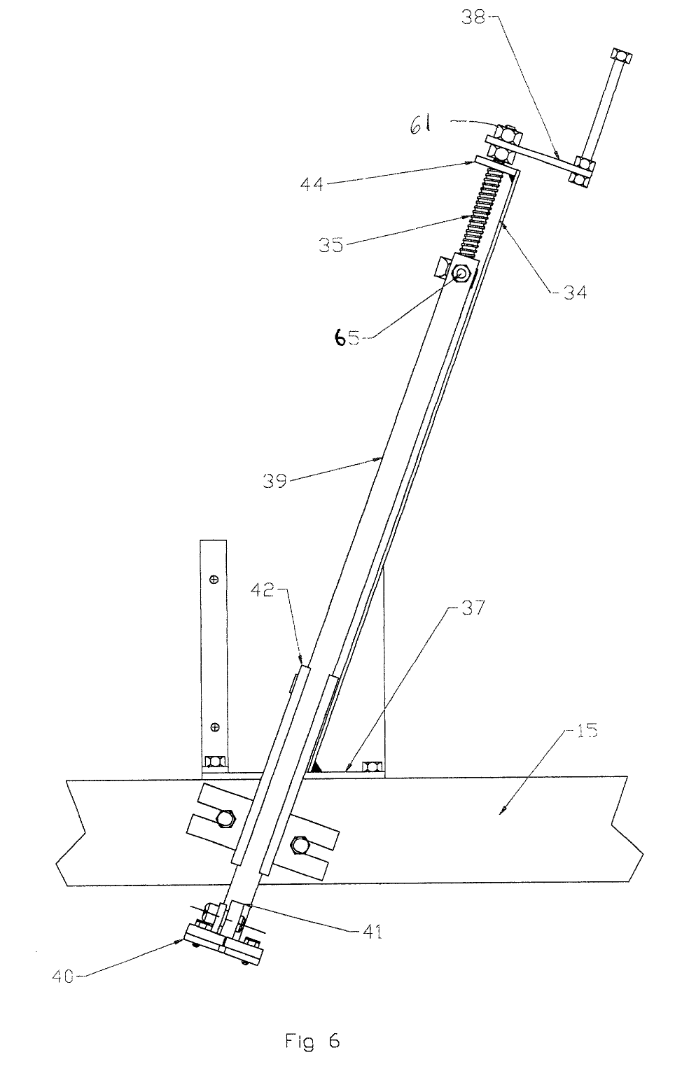

FIG. 6 shows the blade guiding system. This guiding system includes: a support cage which has an L-shaped side bar 34 parallel to the blade 36 with a plate 37 welded onto its base which is secured onto the beam 15 with a bolt. A perforated plate 44 is welded onto the top end of the L-shaped bar 34. This plate is crossed by the end of the transmission bolt 35. A handle 38 is attached to this end of the transmission bolt. A nut 43 securing the transmission bolt 35 has a threaded screw 65 welded onto the transmission bolt which holds the support bar 39 of the support plate 40 of the ball bearing 41. A bar 42 with a spline is bolted to the side of the beam 15 and holds the support bar 39, allowing it to slide along its spline.

A water tank 45 is installed on the beam 18 in order to allow water to fall onto the blade 36 for cooling purposes using the force of gravity.

A protective guard 46 covers the driving belt 50, the motor 17 pulley 49 and the transfer pulley 48. Another protective guard 47 covers the transfer pulley 48, the driving belt 51 and the driving pulley 19. Another protective guard 52 covers the bandsaw blade 36.

A pick in the shape of a rake is installed at one end of the mini-sawing structure. This pick has a metal handle 53 with a welded ring 54 at one end, supported by a tube 55 attached to the supporting end frames 56 and 57 of the structure and parallel to the log. A metal bar 58, which is perpendicular to the handle 53 is welded onto the other end of this handle. This metal bar has steel picks 59 that can be inserted into the end of the log to lock it.

Two supporting end frames 57 are installed at the outer ends of beams 1 and 2 in order to give the guiding bar 23 a bolting point to adjust the alignment of this guiding bar 23.

It will be understood that the above described embodiments are for purposes of illustration only and that changes or modifications may be made thereto without departing from the spirit and scope of the invention

I claim:

1. A portable sawmill for sawing a log, said sawmill comprising;
first and second end frames;
an elevated horizontally extending rail extending between and supported by said first and second end frames;
a carriage component mounted on said horizontally extending rail and being slidably moveable therealong;
a cutting means carried by said carriage, said cutting means including a drive motor and a saw blade assembly, said drive motor and said saw blade assembly being mounted on said carriage component such that each of said drive motor and said saw blade assembly are on opposite sides of said horizontally extending rail to thereby substantially counterbalance each other;
log support means extending between said first and second end frames, said log support means being located below said elevated horizontally extending rail, said log support means including a log support surface inclined with respect to a horizontal plane.

2. The sawmill of claim 1 further including adjusting means for adjusting the position of a log mounted on said log support surface.

3. The portable sawmill of claim 1 wherein said cutting means comprises a band saw.

4. The sawmill of claim 1 further including water dispensing means located to dispense water on a blade of said saw blade assembly.
